(19) United States
(12) Patent Application Publication
(10) Pub. No.: US 2016/0057302 A1
(43) Pub. Date: Feb. 25, 2016

(54) SYSTEM AND METHOD FOR SCANNING OBJECTS

(71) Applicant: AUM Research LLC, Hudson, OH (US)

(72) Inventors: Vithi Mittal, Hudson, OH (US); Rohit Pal, Mechanicville, NY (US)

(21) Appl. No.: 14/472,709

(22) Filed: Aug. 29, 2014

Related U.S. Application Data
(63) Continuation-in-part of application No. 14/467,529, filed on Aug. 25, 2014, now abandoned.

(51) Int. Cl. H04N 1/00

(52) U.S. Cl. CPC H04N 1/00687; H04N 1/00795

(57) ABSTRACT

In a method for scanning a book including a plurality of pages, a property of the plurality of pages is measured between a plurality of points on the top of the book and a plurality of points on the bottom of the book to generate a plurality of data values. The plurality of data values are grouped into a plurality of levels corresponding to the plurality of pages. A determination is made for each of the plurality of the points at each of the plurality of levels whether ink is present. Pixel data is generated, indicative of one of the presence or absence of ink at each of the plurality of points for each of the plurality of levels. An image is generated using the pixel data for each of the plurality of levels.

### CROSS-REFERENCE TO RELATED APPLICATIONS

This application is a continuation-in-part of application Ser. No. 14/467,529 filed on Aug. 25, 2014 which claims priority from U.S. Provisional Patent Application No. 61/869,362 filed on Aug. 23, 2013, which is incorporated by reference herein in its entirety.

### BACKGROUND

Digitizing printed documents provides a variety of benefits. For example, digital documents may be stored and shared electronically and may be more efficiently archived, searched, and reproduced as compared to printed or physical documents. Various types of scanning and image capture devices exist that are able to convert a sheet of paper including text, images, or a combination of both, to a digital format. However, existing scanners and image capture devices are only able to scan or digitize a single page at a time. Thus, processing a stack of pages may be time consuming and inefficient. Moreover, the pages may not be easily separable, as in the case of a book. In such a scenario, the pages of the book must be turned, either manually, or by a machine, in between each page scan.

In addition, it may be desirable to scan the contents of a stack of papers, a book, or an envelope for example, without removing any papers from the stack of papers, without opening the book, or without opening the envelope, for example. Existing scanners do enable such scanning without disturbing the contents of the target to be scanned.

### SUMMARY

In a method for scanning a book including a plurality of pages, a property of the plurality of pages is measured between a plurality of points on the top of the book and a plurality of points on the bottom of the book to generate a plurality of data values. The plurality of data values are grouped into a plurality of levels corresponding to the plurality of pages. A determination is made for each of the plurality of the points at each of the plurality of levels as to whether ink is present. Pixel data is generated, indicative of one of the presence or absence of ink at each of the plurality of points for each of the plurality of levels. An image is generated using the pixel data for each of the plurality of levels.

A system for scanning a book including a plurality of pages includes a first copper grid plate having a first plurality of squares and a semiconductor multiplexing switch for allowing current through a set of pixels corresponding to one of the first plurality of squares in the copper grid, disposed on a first side of a book. The system further includes a second copper grid plate having a second plurality of squares and a semiconductor multiplexing switch for allowing current through a set of pixels corresponding to one of the second plurality of squares in the copper grid, disposed on a second side of the book. The system further includes a power source for providing an electric charge between one of the first plurality of squares and one of the second plurality of squares. The system further includes a measurement device for measuring the voltage across the book between the one of the first plurality of squares and the one of the second plurality of squares. The system further includes a computer with program instructions for determining whether one of a plurality of pixels between the one of the first plurality of squares and the one of the second plurality of squares comprises ink based on the measured voltage.

In a method for scanning a plurality of papers, the electrical capacitance of a plurality of pixels of a plurality of papers disposed between a first metal plate and a second metal plate is measured. It is determined whether each of the plurality of pixels includes ink based on the measured electrical capacitance. A plurality of images corresponding to a plurality of papers are generated based on the determination of whether the plurality of pixels comprise ink.

### BRIEF DESCRIPTION OF THE DRAWINGS

In the accompanying drawings, structures are illustrated that, together with the detailed description provided below, describe example embodiments of the claimed invention. Where appropriate, like elements are identified with the same or similar reference numerals. Elements shown as a single component may be replaced with multiple components. Elements shown as multiple components may be replaced with a single component. The drawings may not be to scale. The proportion of certain elements may be exaggerated for the purpose of illustration.

FIG. 1 illustrates an example system for scanning objects.

FIG. 2 illustrates an example copper metal grid plate including a switching circuit for allowing current through a set of pixels at a time used in the example system of FIG. 1.

FIG. 3 illustrates an example of a dielectric surrounded by metal plates.

FIG. 4 is a cross-section side view of a portion of a book divided into two pixels.

FIGS. 5A and 5B are example schematics of RC circuits where a book acts as a dielectric, surrounded by metal plates to form a capacitor.

FIG. 6 illustrates example measurements taken across pixels of a book.

FIG. 7 is an example coefficient matrix.

FIG. 8 is a flow chart of an example method for scanning objects.

FIG. 9 illustrates an example measurement of inductance of the pixel wise pages of a book.

FIG. 10 illustrates isothermal heat transfer in an object according to one example.

FIG. 11 illustrates adiabatic heat transfer in an object according to one example.

### DETAILED DESCRIPTION

Scanners or image capture devices operate by analyzing how light is reflected by paper and by ink on the paper. Light does not reach the inside of a book when the book is closed, however. Therefore, scanning or examining the content of a book using known scanners or image capture devices is not feasible without opening the book. Described herein is a system and method for scanning a book and determining the contents of the pages inside without opening the book by relying on alternative properties of the ink and paper. Based on the analysis, the book can be digitized and stored in electronic form for archiving, and for distribution and reproduction.

It should be understood that, although the example systems and methods described herein refer to scanning a closed book and determining the content of the pages of the closed book, the systems and methods may similarly be used in other applications to identify content of papers or pages without disturbing the context of the papers, such as a stack of papers, a sealed envelope, and the like.

It should be further appreciated that the systems and methods described herein may similarly be used to perform CT scans and X-Rays for human beings or to examine inorganic objects such as gold or diamonds for cavities and impurities for example.

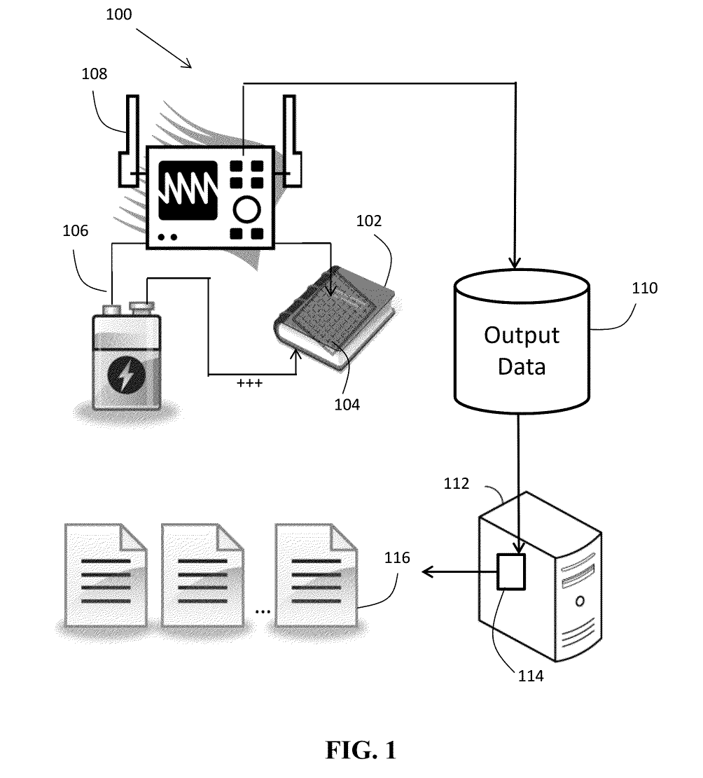

FIG. 1 illustrates a system 100 for scanning a book 102 using electrical capacitance. System 100 includes a first copper grid plate 104 positioned on top of the book 102. The first copper grid plate 104 has a semiconductor multiplexing switch circuit for allowing current through a set of pixels corresponding to one of a plurality of squares of the first copper grid plate 104. System also includes a second copper grid plate (not shown) positioned on the bottom of the book 102. The second copper grid plate has a semiconductor multiplexing switch circuit for allowing current through a set of pixels corresponding to one of a plurality of squares of the second copper grid plate. The paper inside the book 102 acts as a dielectric and therefore a capacitor is formed when electric charge is applied to the two copper grid plates 104 including the semiconductor circuits.

A pixel is defined as a portion of a page of the book 102. The metal plates include squares corresponding to a set of vertical pixels going through the book 102. The pages of the book 102 may be divided up into any suitable number of pixels. Dividing up the book 102 into a greater number of pixels results in a greater resolution of a scan of the book 102.

System 100 includes a power source 106, which can be AC or DC, for delivering an electrical voltage to the first copper grid plate 104 and to the second copper grid plate. In one example, power source 106 may be a DC circuit defined by the universal time constant formula:

Vc−Vs(1−e−t/RC) equ. (1)

Where

Vc is the voltage across the capacitor;

Vs is the supply voltage;

t is the elapsed time since the application of the supply voltage; and

RC is the time constant of the RC charging circuit.

In another example, power source 106 may be an AC circuit where the current is defined by the equation:

Z=\sqrt{R²+X²} equ. (2)

where, X=X_{c}=½πfC when connected to a AC source. Z=V/I is computer where I is the measured current.

Paper that includes ink, however, exhibits different properties than paper without ink and therefore produces different values of capacitance when acting as a dielectric in between the metal grid squares through which the current is active. Measuring the value of the capacitance of the book indicates whether there is any ink present inside the book and how much ink is present.

System 100 includes a measurement device 108 such as an Attofarad Capacitance Measurement Instrument for measuring the capacitance of the book in combination with the two copper grid plates 104. Measurement device 108 produces and stores data readings in output data 110. The data readings include information about whether the measured capacitance indicates the presence of ink or not in the paper. Output data 110 can be a database, a flat file such as an Excel file, or any other suitable data storage format.

For a pixel area of 1 and depth of 1 cm, the following equation ca be used:

$$C = \frac{ɛ A}{d} = \frac{k {ɛ}_{0} A}{d} \qquad equ . ( 3 )$$

Using the above equation, C=k*8.84*10⁻¹²*0.070004163889*10⁻⁶/0.01, where 0.070004163889*10⁻⁶ m² is area of 1 pixel, 1 aF=0.000001 pF=10⁻¹⁸ F. This calculated C is in Attofarad. In one example where the minimum resolution a measuring interment may take is in Attofarad, taking a minimum reading in Attofarad might lead to errors. Thus, an area larger than one pixel of the metal plate is covered. For example, a positive voltage is applied on one side while a negative voltage is applied on the other side. The reading C can be taken, after which one pixel line voltage is dropped and a reading C is taken again. The two readings are subtracted to find the reading C of 1 pixel line of the book with a depth of r pages.

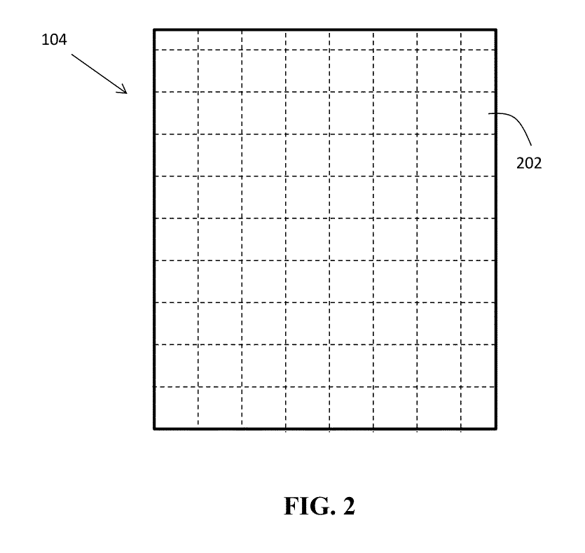

In order to determine the contents of the pages of the book 102, system 100 divides up the book 102 into multiple pixels, applies voltage to the pixels, and takes a capacitance reading at the pixels. FIG. 2 illustrates an example copper grid plate 104 having a plurality of squares 202 and a semiconductor multiplexing switch (not shown). In one example, the squares 202 are copper. Voltage can be applied to any of the squares 202 in order to create a capacitance across a pixel or a portion of the book 102. The result output data thus includes many readings of many pixels of the book. It should be understood that although the example copper grid plate 104 having a semiconductor multiplexing switch includes eighty squares, the example copper grid plate 104 may include any suitable number of squares. In particular, the number of squares is proportional to the number of readings that are able to be obtained and therefore proportional to the granularity of the final image obtained. In one example, the width of a square 202, and therefore the width of a measure pixel, is measured in microns.

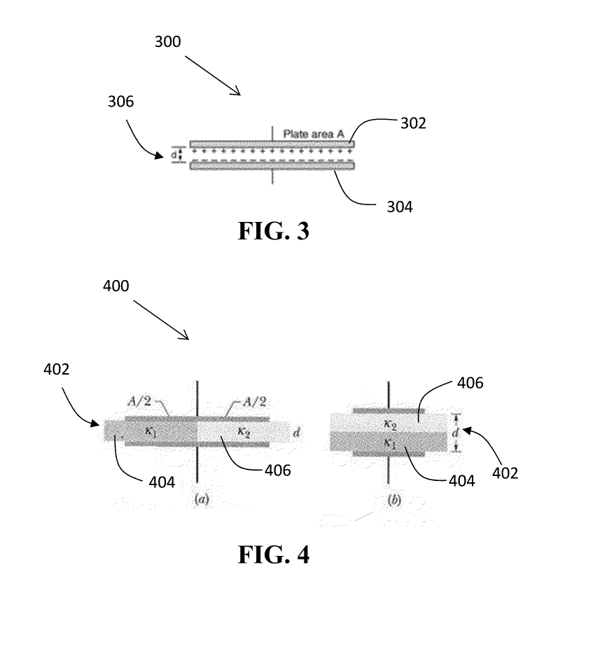

A capacitor 400, as illustrated in FIG. 3, includes a top metal plate 302 with a positive charge and bottom metal plate 304 with a negative charge, separated by a distance D 306. The equation to determine the capacitance C of capacitor 300 is defined as

$$C = \frac{ɛ A}{d} = \frac{k {ɛ}_{0} A}{d} \qquad equ . ( 4 )$$

where the constant

∈ₙ=8.854×10⁻¹² Flm equ. (5)

and k is equal to relative permittivity of the dielectric material between the plates. K is approximately equal to 1 for air or free space and k is greater than 1 for all media such as paper. A is equal to the area of metal plates 302 and 304 and D is equal to the distance between the metal plates 302 and 304.

Since book pages are dielectric, attaching charged copper grid plates 104 to opposite ends of the book 102 causes the combination to act as a capacitor. By dividing up the copper grid plate 104 into squares 202 or pixels, multiple combinations of capacitors can be formed depending on which squares 202 receive the charge. Each capacitor is one pixel area dielectric and the number of dielectric in series is determined by the depth and the thickness of the book surrounded by metal plates or the semiconductor plates on top and on the bottom.

The book 102 contains n pixels length, m pixels width, 1 pixels height, and a total of r pages. When charged metal conductors are joined by copper wire capacitance can be measured by the formula C=q/V.

Also, 1/C1+1/C2+ . . . +1/Cr=1/C where, C1 and C2 is the capacitance of one pixel cross-section of the book 102, in series. FIG. 4 illustrates a cross-section side view 400 of a portion of a book 402 divided up into two pixels 404 and 406. Pixel 404 has a first relative permittivity K1 and pixel 406 has a second relative permittivity K2. This indicates that the first pixel 404 includes ink while the second pixel 406 does not include ink. As indicated by (a) and (b), the pixels 404 and 406 may be in series to one-another or in parallel.

The book will start acting as a capacitor rather than a resistor as Resistance of the book is typically 1 Mohms and C=3.0989 to 2.92 femtofarad, for metal plates 0.001 m by 0.001 m in area and gap between plates=0.01 m. Thus, RC (time constant) is low, so the capacitor will charge up quickly. The internal resistance of the book 102 does not allow for leakage current to flow through the book capacitor. Thus the book is a good dielectric and increases the capacitance of a capacitor.

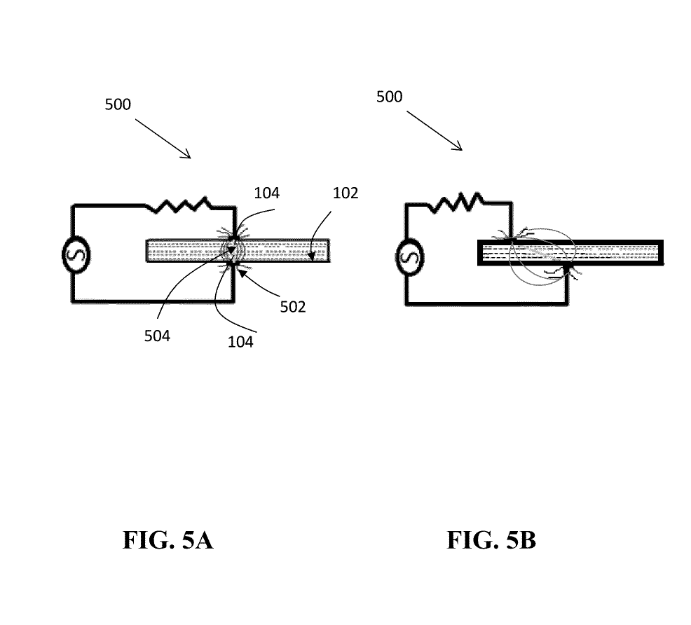

FIGS. 5A and 5B illustrate an RC circuit where a book 102 acts as a dielectric, surrounded by copper grid plates 104 to form a capacitor. The copper grid plates 104 that surround the dielectric book 102 are the source of electrolytic lines of force 502, showing that the shortest distance 504 between the copper grid plates 104 is the maximum effect of electrolytic line force. So the inverse sum of the little capacitors in series along the shortest distance line 504 is the inverse of the total capacitance in the circuit. This is applicable when the electric charge is applied to points directly perpendicular to on-another as in FIG. 5A and also when the electric charge is applied to points diagonally as in FIG. 5B.

To obtain the multiple data points, (n)(m) readings of voltage drop across opposite facing squares 202 in the book's 102 opposite facing sides are measured, considering across top and bottom only. There are (l)(m)(n) variables since the book 102 is 3-dimensional. So to factor in the multiple pages or layers of the book 102, a diagonal reading is taken as well. Thus, one readings of C₁₁ is

$$\text{?} + \text{?} + \text{?} + … + \text{?} = 1 / f 11 \\ \text{?} \text{indicates text missing or illegible when filed} \qquad equ . ( 6 )$$

Measuring voltage across opposite side ends yields (l)(m)+(n)(l)+(n)(m) readings.

Measuring diagonal readings cross-section in the book 102 with charged squares 202 on copper grid plates 104 on the diagonals, the number of readings increases (nm)² as compared to considering only top down readings. These additional data points enable the analysis of the book in 3-dimensions rather than just a single page. Since the capacitance C measured is either the capacitance of air, paper, or ink, measuring C at a pixel indicates whether there is ink or paper at a pixel.

In one example, a book includes 600 by 825 pixels on the top surface so there are (600*825)̂2 linear equations to solve. For improved efficiency and for facilitating real time calculations, the book may be divided into slices to form a lesser 600̂2 linear equations for each slice. The number of pages r of the book determines r*600 variables. The slices can then be individually solved for more efficiently since a slice of the book includes 600 pixels by 1 pixel. The number of slices, 825 for example, is determined by the length of the book.

Referring back to FIG. 1, system 100 includes a computer having data conversion software 114. The data conversion software 114 receives the data from output data 110 and converts it to a digital image, thus recreating the content of the physical book 102 in digital form without opening the book. The conversion software may save the digital image as one or more electronic files 116 such as PDF files, JPEG files, or another suitable digital format for storing an image.

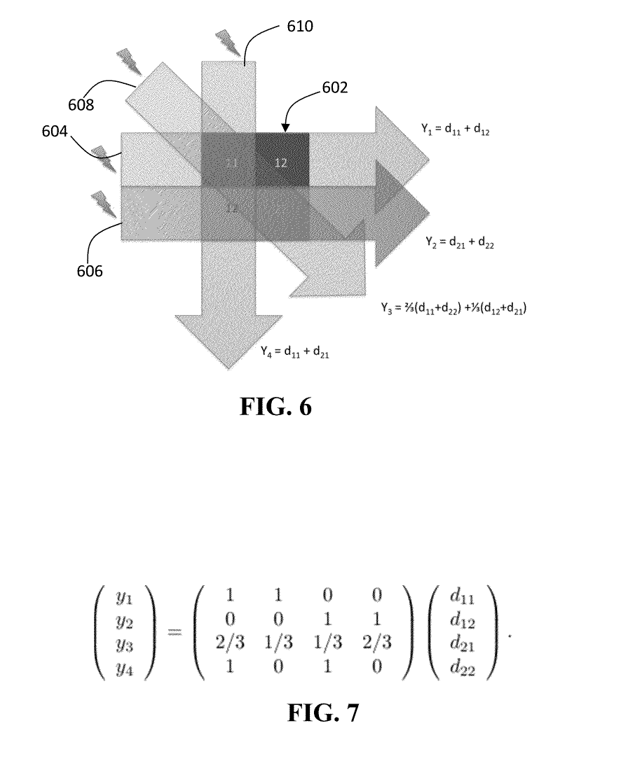

To create the digital image, the data conversion software 114 first solves mn*mn linear equations in lmn variables which represent the readings taken across multiple levels corresponding to the multiple pages of the book 102. FIG. 6 illustrates an example level or slice of a book divided up into 4 pixels 602. In the example illustrated, 4 data readings Y have been taken. In particular, a first reading Y1 604 is a horizontal reading and is equal to the sum of the capacitance values across pixels 11 and 12. A second reading Y2 606 is also a horizontal reading and is equal to the sum of the capacitance values across pixels 21 and 22. A third reading Y3 608 is a diagonal reading and is equal the sum of a portion of each of the pixels 11, 12, 21, and 22. A fourth reading Y4 610 is a vertical reading and is equal to the sum of the capacitance values across pixels 11 and 21.

To determine the inverse capacitance values D at each of the pixels 11, 12, 21, and 22, 4 equations are solved to find the total inverse of capacitance readings. In particular, Y1, Y2, Y3, and Y4 are solved using an example coefficient matrix (1, 0, 2/3) illustrated in FIG. 7. Once the values for each pixel are solved, it can be determined whether the pixel includes include ink, paper, or a combination of both. This pixel data can then be used to recreate an image and save the image as an electronic file such as a PDF or GIF for example. Software classes such as the Java drawimage class or the Microsoft BitMap class can be used to create an image based on the calculated pixel data.

It should be appreciated that the example illustrated in FIG. 6 is simplified for the purpose of describing the process for taking capacitance measurements and gathering data about a book. Given the shape of the book 102 and the top and bottom readings taken straight or diagonally, there is potentially a large set of linear equations to solve for. For example, when pixels are measured in microns, there is a potential for a million or more equations to solve for. SuiteSparseQR, for example, is a software available in Matlab to solve for very large linear equations.

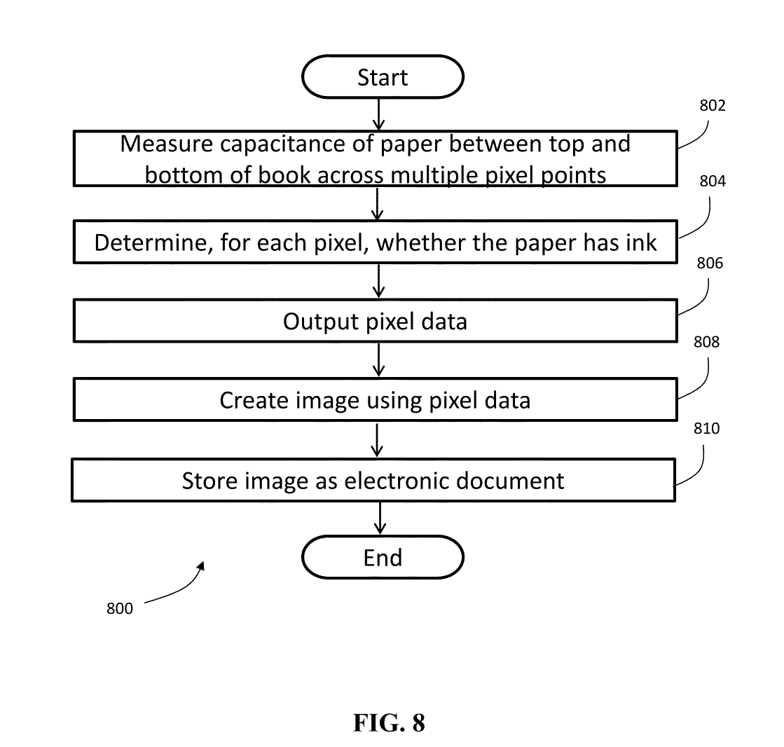

FIG. 8 is a flow chart illustrating an example method for scanning a book. At step 802, the measurement device 108 measures properties across a paper between the top and bottom of a book, across multiple pixel points. In one example, measurement device 108 measures capacitance. At step 804, based on the measurements, computer 112 determines for each pixel whether the paper has ink. At step 806, the computer 112 produces pixel data and creates an image using the pixel data at step 808. At step 810, the computer 112 stores the created image as an electronic document.

It should be appreciated that although the example system and method described measures capacitance across pixels of the book in order to determine the contents of the book, other techniques such as X-Ray CT scanning may be relied on for the purpose of determining the contents of the book.

In one example, the thermal conductivity of paper may be used to determine whether the pixels of paper of a book include ink. Heat is applied to the top of the book where the temperature is monitored. By calculating the temperature gradient of a point or a pixel inside of the book based on the monitored outside temperature, the contents of the inside of the book can be determined since a pixel of paper with ink has a different thermal coefficient and therefore conducts heat differently compared to a pixel of paper without ink. The heat has to reach the opposite pixel of the opposite side of paper stack. The time taken to do that and reach a steady state can be calculated by calibrating for the all cuboid ink case.

dQ/dt=q in watts of microwave and top 1 surface is heated up and the other 5 surfaces are not. Further, suppose there are m pixels of paper on heated of the outermost surfaces and n pixels of ink, then the effective coefficient of thermal conductivity is:

Koff=(m−k1+n−k2) equ. (7)

for parallel pixels or perpendicular to heat and

Koff=1/(m/k1+n/k2) equ. (8)

for series pixels or parallel to heat. Therefore:

$$\begin{matrix} Koff = k 1 * \text{?} & equ . ( 9 ) \\ q = \frac{{T}_{1} - {T}_{g}}{Δ {x}_{A} / ( {k}_{A} A ) + 1 / ( \text{?} A ) + Δ \text{?} / ( {k}_{B} A )} & equ . ( 10 ) \\ Δ {q}_{x} = \frac{{dT}_{x}}{\sum ( ( \text{?} ) + \frac{dx}{{Ak}_{p}} + \frac{dx}{( {m}_{i + 1} k + ( a - {m}_{i + 1} ) {k}_{p} )} + \frac{1}{A {h}_{c}} )} & equ . ( 11 ) \\ Δ {q}_{y} = \frac{{dT}_{y}}{\sum ( \frac{dy}{\begin{matrix}\sum ( {n}_{ik} k + ( b - {n}_{ik} ) {k}_{p} + {bk}_{p} + \\ {n}_{i + 1 k} k + ( b - {n}_{i + 1 k} ) {k}_{p} )\end{matrix}} + \frac{1}{{A}^{′} {h}_{c}} )} & equ . ( 12 ) \\ Δ {q}_{z} = \frac{{dT}_{z}}{\sum ( \frac{dz}{\begin{matrix}\sum ( {s}_{ij} k + ( c - {s}_{ij} ) {k}_{p} + {ck}_{p} + \\ {s}_{i + 1 j} k + ( c - {s}_{i + 1 j} ) {k}_{p} )\end{matrix}} + \frac{1}{{A}^{″} {h}_{c}} )} & equ . ( 13 ) \\ \text{?} \text{indicates text missing or illegible when filed} & \end{matrix}$$

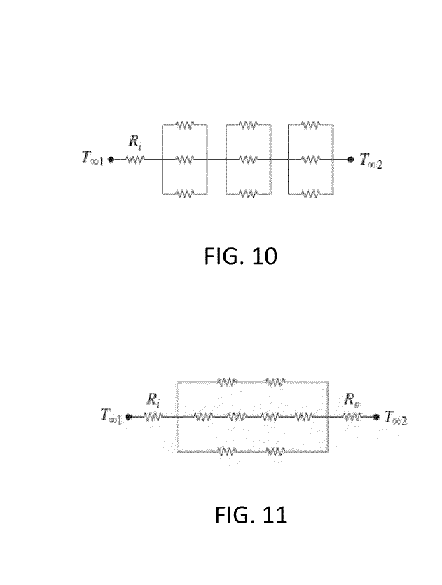

Assuming isothermal conditions, the book Δq is taken as a whole and ‘a’ is the total number of pixels in y-z plane; ‘b’ is the total number of pixels along the y-axis; and ‘c’ is the total number of pixels along the z-axis as illustrated in FIG. 10.

Assuming adiabatic conditions and simplifying for end temperatures we get:

$$\begin{matrix} Δ q 111 - 11 nx = \frac{A ( T 111 - T 11 n )}{\frac{d x}{k 111} + \frac{dx}{kp} + \frac{dx}{k 112} + \text{?} + … + \frac{dx}{k 11 n}} & equ . ( 14 ) \\ \text{?} \text{indicates text missing or illegible when filed} & \end{matrix}$$

Here we are assuming adiabatic conditions our outer Δqᵢⱼₖₓ=(q−heat loss to atmosphere from all six sides)/(A)(2 mn+2 lm+2 nl), where A is top surface area of book and where top side is heated=m*n not in meter². A in this equation is the area of 1 pixel in meters². Heat is assumed to be divided equally for all directions for going to all pixels from one pixel.

Thus there are lm+nl+mn equations from the above equation from 2(ml+nl+nm) temperature readings on the outer surfaces and lmn variables inside the book. This leads to solving for lmn variables, since heat travels from pixel 111 to 12n also and takes the shortest route to calculate it as illustrated in FIG. 11. There are (nm)² readings considering only top-down readings.

$$Δ q 111 - 12 nx = \frac{A ( T 111 - T 12 n )}{\frac{dx}{k 111} + \frac{dy}{k 121} + \frac{dz}{kp} + \frac{dx}{k 122} + \text{?} + … + \frac{dx}{k 12 n}} \\ \text{?} \text{indicates text missing or illegible when filed} \qquad equ . ( 15 )$$

For the outermost surface, heat lost to atmosphere must also be considered.

$$\frac{d Q}{d t} = h \cdot A ( T ( t ) - {T}_{env} ) = - h \cdot A Δ T ( t ) \qquad equ . ( 16 )$$

Thus q−dQ/qt=heat input in the book.

Newton's cooling law is a solution of the differential equation given Fourier's law: Where Q is the thermal energy in joules;

h is the heat transfer coefficient (assumed independent of T here) (W/m² K);

a is the surface area of the heat being transferred (m²);

T is the temperature of the object's surface and interior; and

Tₑₙᵥ is the temperature of the environment; i.e. the temperature suitably far from the surface. Thus,

$${q}_{111 \_ 11 nx} - {h}_{c} \cdot A ( {T}_{top} - {T}_{env} ) - {h}_{c} \cdot A ( {T}_{bottom} - {T}_{env} ) = \frac{A ( T 1 - Tn )}{\text{?} + \text{?} + \text{?} + \text{?} + … + \text{?}} \\ \text{?} \text{indicates text missing or illegible when filed} \qquad equ . ( 17 )$$

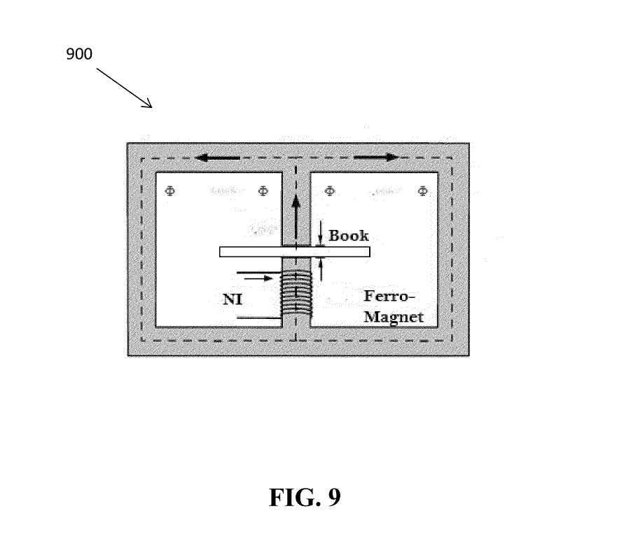

In one example, a book may be scanned using magnetic inductance. FIG. 9 illustrates an example measurement of inductance of the pixel wise pages of a book. Using the equation V=−Ldi/dt, the voltage drop in terms of current in the circuit is measured. In particular, the voltage drop of the whole core consisting of the ferromagnetic structure and air gap, or the book, is measured.

Reluctance (total)=Rₚₒₗₑ+Rₚₒₗₑ+R_{gap}+R_{outer/2} and R_{gap}=reluctance of ink and paper.

Where

$${R}_{1} = \frac{l}{μ A}$$

etc.

The μ magnetic permeability is found by computing the effective permeability of paper and paper with ink or air contact

L=N*(flux of magnetic field)/current

(Flux of magnetic field)=NI/(R total)

$$L = {N}^{2} ( μ \frac{A}{l} + … )$$

AC Current is:

z−\sqrt{R²−x²}

where, X=X_{L}=2πfL when connected to a AC source. Z=V/I is computed where I is the measured current. A DC source inductor follows the same Universal Time Formula as a capacitor except:

τ=L/R

Readings are take at different positions on the book. Some readings are taken diagonally opposite. The number of readings obtained is equal to (nm)² considering only top down readings and (l)(m)(n) variables.

In one example, the thickness of ink and paper may not be constant. Thus, in one example, the systems and methods described herein may be calibrated for variances in thickness as well as humidity, different ink densities, and dust or other particles on the book.

It should be understood that, although some of the examples that have been described make reference to scanning a book, the system and method described herein may be used to scan other objects as well. For example, an x-ray of a person may be taken by applying heat or cooling the body and taking a temperature reading on the body surface. In one example, scanning using ultra sounds may similarly be used.

Some portions of the detailed descriptions are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

While example systems, methods, and so on, have been illustrated by describing examples, and while the examples have been described in considerable detail, it is not the intention to restrict or in any way limit the scope of the appended claims to such detail. It is simply not possible to describe every conceivable combination of components or methodologies for purposes of describing the systems, methods, and so on. With the benefit of this application, additional advantages and modifications will readily appear to those skilled in the art. The scope of the invention is to be determined by the appended claims and their equivalents.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

1. A method for scanning a book comprising a plurality of pages, the method comprising the steps of:
measuring a property of the plurality of pages between a plurality of points on the top of the book and a plurality of points on the bottom of the book to generate a plurality of data values;
grouping the plurality of data values into a plurality of levels corresponding to the plurality of pages;
determining for each of the plurality of the points at each of the plurality of levels whether ink is present;
generating pixel data indicative of one of the presence or absence of ink at each of the plurality of points for each of the plurality of levels; and
generating an image using the pixel data for each of the plurality of levels.

2. The method of claim 1, wherein the step of measuring a property of the plurality of pages between a plurality of points on the top of the book and a plurality of points on the bottom of the book comprises measuring the property between a first point perpendicular to a second point.

3. The method of claim 1, wherein the step of measuring a property of the plurality of pages between a plurality of points on the top of the book and a plurality of points on the bottom of the book comprises measuring the property between a first point diagonal to a second point.

4. The method of claim 1, wherein the property measured comprises capacitance.

5. The method of claim 4, wherein the step of measuring a property of the plurality of pages between a plurality of points on the top of the book and a plurality of points on the bottom of the book comprises:
disposing on the top of the book a first copper plate including a semiconductor circuit, the copper plate comprising a plurality of points corresponding to the plurality of points on the top of the book;
disposing on the bottom of the book a second copper plate comprising a semiconductor circuit, the copper plate comprising a plurality of points corresponding to the plurality of points on the bottom of the book;
applying electrical charges between the plurality of points on the first copper plate and the plurality of points on the second copper plate; and
measuring the voltage across the book between the plurality of points on the first copper plate and the plurality of points on the second copper plate.

6. The method of claim 5, wherein the step of determining for each of the plurality of the points at each of the plurality of levels whether ink is present comprises solving a coefficient matrix of the measured voltage across the book.

7. The method of claim 1, wherein the property measured comprises thermal conductivity.

8. The method of claim 7, wherein the step of measuring a property of the plurality of pages between a plurality of points on the top of the book and a plurality of points on the bottom of the book comprises:
applying heat to an outer surface of the book;
monitor the temperature on the outer surfaces of the book;
calculate a temperature gradient of a pixel inside of the book based on the monitored temperature; and
determine whether the pixel inside of the book comprises ink based on the temperature gradient.

9. The method of claim 1, wherein the property measured comprises inductance.

10. A system for scanning a book comprising a plurality of pages, the system comprising:
a first copper grid plate comprising a first plurality of squares and a semiconductor multiplexing switch for allowing current through a set of pixels corresponding to one of the first plurality of squares, disposed on a first side of a book;
a second copper grid plate comprising a second plurality of squares and a semiconductor multiplexing switch for allowing current through a set of pixels corresponding to one of the second plurality of squares, disposed on a second side of the book;
a power source for providing an electric charge between one of the first plurality of squares and one of the second plurality of squares;
a measuring device for measuring the voltage across the book between the one of the first plurality of squares and the one of the second plurality of squares; and
a computer comprising program instructions for determining whether one of a plurality of pixels between the one of the first plurality of squares and the one of the second plurality of squares comprises ink based on the measured voltage.

11. The system of claim 10, wherein the first plurality of squares and the second plurality of squares comprise copper.

12. The system of claim 10, wherein the program instructions for determining whether one of a plurality of pixels between the one of the first plurality of squares and the one of the second plurality of squares comprises ink determines whether the one of the plurality of pixels comprises ink by calculating a coefficient matrix of measured capacitance between a plurality of the first plurality of squares and a plurality of the second plurality of squares.

13. The system of claim 10, wherein the computer further comprises program instructions for receiving data indicative of whether each of a plurality of pixels between the first copper plate and the second copper plate comprise ink and for converting the pixel data to an image.

14. The system of claim 13, wherein the computer further comprises program instructions for creating an electronic data file comprising the image.

15. The system of claim 10, wherein the power source provides an electric charge between one of the first plurality of squares and one of the second plurality of squares perpendicular to the one of the first plurality of squares.

16. The system of claim 10, wherein the power source provides an electric charge between one of the first plurality of squares and one of the second plurality of squares diagonal to the one of the first plurality of squares.

17. A method for scanning a plurality of papers comprising the steps of:
measuring the electrical capacitance of a plurality of pixels of a plurality of papers disposed between a first metal plate and a second metal plate;
determining whether each of the plurality of pixels comprise ink based on the measured electrical capacitance; and
generating a plurality of images corresponding to a plurality of papers based on the determination of whether the plurality of pixels comprise ink.

18. The method of claim 17, wherein the step of measuring the electrical capacitance of the plurality of pixels comprises:
applying electrical charges between a plurality of points on the first metal plate and a plurality of points on the second metal plate; and
measuring the electrical voltage across the plurality of papers between the plurality of points on the first metal plate and the plurality of points on the second metal plate.

19. The method of claim 18, wherein the step of determining whether each of the plurality of pixels comprise ink comprises solving a coefficient matrix of the measured stored electrical voltage to determine the stored electrical voltage at each of the plurality of pixels.

20. The method of claim 17, further comprising the step of generating a plurality of electronic data files comprising the plurality of images.

21. The method of claim 17, wherein the plurality of papers comprises a sealed envelope comprising at least one paper disposed inside.

22. The method of claim 17, wherein the plurality of papers comprises a book comprising a plurality of pages.
